(19) United States
(12) Patent Application Publication
(10) Pub. No.: US 2006/0129827 A1
(43) Pub. Date: Jun. 15, 2006

(54) Method of revoking public key of content provider

(75) Inventors: Chi-hurn Kim, Hwaseong-si (KR); Yong-kuk You, Seoul (KR); Su-hyun Nam, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/298,874

(22) Filed: Dec. 12, 2005

Related U.S. Application Data
(60) Provisional application No. 60/634,575, filed on Dec. 10, 2004.

(30) Foreign Application Priority Data
Dec. 24, 2004 (KR) 10-2004-0112241

(51) Int. Cl. H04L 9/00

(52) U.S. Cl. 713/176

(57) ABSTRACT

A method of revoking a public key of a content provider is provided. In a system in which a certificate authority certifies the public key of the content provider and the content provider transmits predetermined content to a user device using the certified public key, the method includes the user device determining whether the predetermined content is revoked by comparing a time when a signature of the public key is generated with a time when the public key is revoked. Accordingly, it is possible to allow the user device to identify content that must not be revoked according to the time when the public key is revoked and a revocation list which includes an exception list, thereby preventing rightly obtained content from being revoked.

### CROSS-REFERENCE TO RELATED PATENT APPLICATIONS

This application claims the priorities of U.S. Provisional Application No. 60/634,575, filed on Dec. 10, 2004, with the US PTO, and Korean Patent Application No. 10-2004-0112241, filed on Dec. 24, 2004, in the Korean Intellectual Property Office, the disclosures of which are incorporated herein in their entirety by reference.

### BACKGROUND OF THE INVENTION

1. Field of the Invention

The present invention relates to a method of revoking content authority using a revocation list, and more particularly, to a method of revoking a public key of a content provider in a system in which a certifying authority certifies the public key of the content provider and the content provider transmits content to a user using the certified public key.

2. Description of the Related Art

Content is provided from a content manufacturer to a content provider, and the content provider transmits the content to a user device. For instance, the content manufacturer is a studio, and the content provider is an Internet business firm or a disc manufacturing company that changes the content into mass media files and distributes them to a user device.

The user device is designed to determine whether the content provider is an authorized content provider and to reproduce the content after the content provider is determined to be an authorized content provider. This is because a content right may be terminated at the expiration of a contract or a content provider may try to disguise himself or herself as another content provider.

A method of determining whether a content provider is an authorized content provider, i.e., a method of authenticating the content provider, includes user authentication that determines whether the content provider is a revoked content provider and whether the content provider disguises himself or herself as another content provider. The former is performed using a revocation list and the latter is performed using an electronic signature.

FIG. 1 is a flowchart of a conventional method of revoking content authority. FIG. 2 is a diagram illustrating a structure of a revocation list used in the method of FIG. 1.

Referring to FIG. 1, a certificate authority CA makes a certificate C_CA_CP that certifies a CP public key PK_CP of a content provider CP and transmits a certificate to the CP (operation 110). The certificate C_CA_CP includes a signature value S1 generated by electronically signing the public key PK_CP using a private key SK_CA, and the public key PK_CP. The certificate C_CA_CP may be expressed as follows:
C_{—}CA_{—}CP=S1||PK_{—}CP=S(SK_{—}CA, PK_{—}CP)||PK_{—}CP (1)

Next, the content provider generates content Cont and a certificate C_CP_UD that certifies the content Cont and transmits them to a user device UD (operation 120). The CP certificate C_CP_UD includes the certificate C_CA_CP, and a signature value S2 generated by electronically signing the content Cont using a private key SK_CP of the content provider. The certificate C_CP_UD may be expressed as follows:

$$C\_CP \_UD = C\_CA \_CP ‖ S 2 = S 1 ‖ PK\_CP ‖ S 2 = S ( SK\_CA , PK\_CP ) ‖ PK\_CP ‖ S ( SK\_CP , Cont ) \qquad ( 2 )$$

Next, the user device UD extracts the signature values S1 and S2 and the public key PK_CP from the certificate C_CP_UD (operation 130).

Next, the user device UD determines whether the certificate C_CP_UD is revoked by checking whether a revocation list RL includes the public key PK_CP extracted in operation 130 (operation 140). As illustrated in FIG. 2, the revocation list may include a public key PK_CP of a revoked content provider. When the revocation list does not include the public key PK_CP, the method proceeds to operation 150, and otherwise, the method proceeds to operation 170.

In operations 150 and 160, user authentication in which the validity of the public key PK_CP is checked.

Specifically, the user device UD determines whether verification of the content Cont succeeds or fails by inputting the signature value S2 and the public key PK_CP of the content provider CP, and the content Cont into a verification function V( ) (operation 150). That is, whether the content Cont has been signed using the private key SK_CP is verified. In this case, the verification function V( ) is expressed as follows:
V(S2, PK_{—}CP, Cont)=V(S(SK_{—}CP, Cont), PK_{—}CP, Cont)=Success or Fail (3)

When the verification succeeds, the method proceeds to operation 160, and otherwise, the method proceeds to operation 170.

Specifically, the user device UD determines whether verification of the public key PK_CP succeeds or fails by inputting the signature value S1 and the public key PK_CA of the certificate authority CA, and the public key PK_CP of the content provider CP into the verification function V( ) (operation 160). That is, it is determined whether the public key PK_CP has been signed using the private key SK_CP of the certificate authority CA. In this case, the verification function V( ) is expressed as follows:
V(S1, PK_{—}CA, PK_{—}CP)=V(S(SK_{—}CA, PK_{—}CP), PK_{—}CA, PK_{—}CP)=Success or Fail (4)

Next, if the user device UD does not authenticate the content provider CP as an authorized content provider the user device rejects reproduction of the content Cont (operation 170). That is, the user device UD determines the content provider CP as a revoked content provider when the public key PK_CP extracted in operation 130 is included in the revocation list, or as a content provider who disguises himself or herself as another content provider when verification is determined to fail in operation 150 or 160. In these cases, the user device UD rejects reproduction of the content Cont.

However, in the method of FIG. 1, when the user device UD was in an offline state when the content provider CP was revoked and thus did not substitute a new certificate for a certificate of content received before the content provider CP was revoked, the user device UD cannot reproduce all content Cont received from the content provider CP.

It is assumed that the certificate authority CA transmits its certificate C_CA_CP to the content provider CP, the content provider CP transmits the first content Cont_1 to the user device UD using the certificate C_CP_UD of the content provider CP, a revocation list RL stored in the user device UD is updated to include the certificate C_CP_UD at a time t1, and the content provider CP transmits second content Cont_2 to the user device UD using the revoked certificate C_CP_UD.

In this case, the user device UD performs user authentication, which is described with reference to FIG. 1, for both the first and second contents Cont_1 and Cont_2 using the revoked certificate C_CP_UD, and thus cannot reproduce both the first content Cont_1, and the second content Cont_2 transmitted after the time t1. However, if the content provider CP is revoked for only a business reason, it is unreasonable to prevent the user device UD from using the first content Cont_1 transmitted to the user device UD from the content provider CP before the time t1 when the content provider CP was revoked.

### SUMMARY OF THE INVENTION

The present invention provides a method of authenticating a content provider, which allows reproduction of content transmitted from the content provider before the content provider is revoked and a certificate of the revoked content provider cannot be updated, and revoking the content provider using the same.

According to one aspect of the present invention, there is provided a method of revoking a public key of a content provider in a system in which a certificate authority certifies the public key of the content provider and the content provider transmits predetermined content to a user device using the certified public key, the method comprising determining whether the predetermined content is revoked in the user device by comparing a time when a signature of the public key is generated with a time when the public key is revoked.

The method further includes the certificate authority electronically signing a time when the predetermined content is electronically signed and the public key of the content provider, and transmitting the result of signing to the content provider, and the content provider electronically signing the predetermined content and transmitting the predetermined content to the user device.

According to another aspect of the present invention, there is provided a method of revoking a public key of a content provider in a system in which a certificate authority certifies the public key of the content provider and the content provider transmits predetermined content to a user device using the certified public key, the method comprising the user device determining whether the predetermined content is revoked based on whether a content identifier of the predetermined content is included in an exception list which lists content identifiers of contents that must not be revoked.

The method further includes the certificate authority electronically signing a content identifier of the predetermined content and the public key of the content provider and transmitting the signed content identifier and public key to the content provider, and the content provider electronically signing the predetermined content and transmitting the predetermined content to the user device.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a flowchart of a conventional method of revoking content authority;

FIG. 2 is a diagram illustrating a structure of a revocation list used in the method of FIG. 1;

FIG. 3 is a flowchart of a method of revoking content authority according to an embodiment of the present invention;

FIG. 4 is a diagram illustrating a structure of a revocation list used in the method of FIG. 3;

FIG. 5 is a flowchart of a method of revoking content authority according to another embodiment of the present invention;

FIG. 6 is a diagram illustrating a structure of a revocation list used in the method of FIG. 5;

FIG. 7 is a flowchart of a method of revoking content authority according to yet another embodiment of the present invention; and

FIG. 8 is a diagram illustrating a structure of a revocation list used in the method of FIG. 7.

### DETAILED DESCRIPTION OF THE INVENTION

The present invention introduces two methods of preventing improper revocation of content authority. In the first method, a revocation list is made to include information regarding a time when the content authority is revoked. In the second method, the revocation list includes a content identifier for identifying the content of which content authority must not be revoked. A signature value of a certificate authority that the first method requires is different from that of the certificate authority that the second method requires.

More specifically, in the first method, a certificate authority inserts information regarding a time when a signature of the certificate authority is made into a certificate to be provided to a content provider. Next, a revocation list, which is to be transmitted to a user device includes both a public key of a content provider to be revoked and information regarding a time when the public key is revoked. Lastly, the user device determines whether each content authority must be revoked, according to the time when the signature is made and the time when the public key is revoked.

In the second method, a certificate authority inserts a content identifier to be signed into a certificate of the certificate authority to be provided to a content provider. Next, a revocation list, which is to be transmitted to a user device, includes both a public key of a content provider to be revoked, and an exception list specifying an identifier of content that must not be revoked. Lastly, the user device determines whether each content authority must be revoked, using the content identifier and the exception list.

Hereinafter, exemplary embodiments of the present invention will be described in detail with reference to the accompanying drawings.

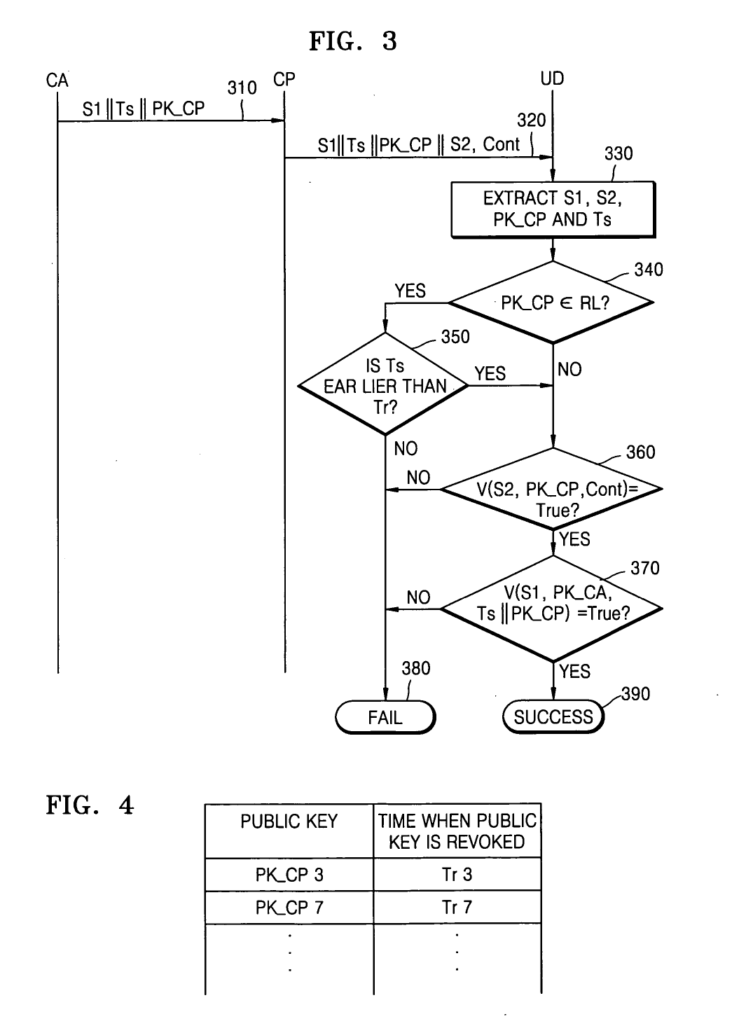

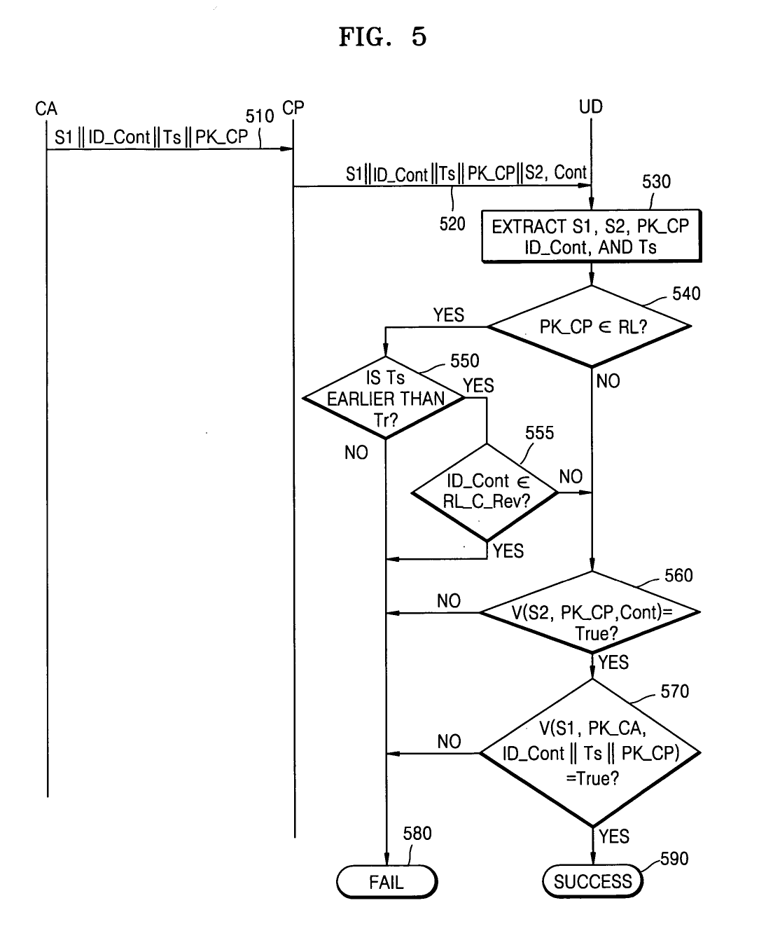

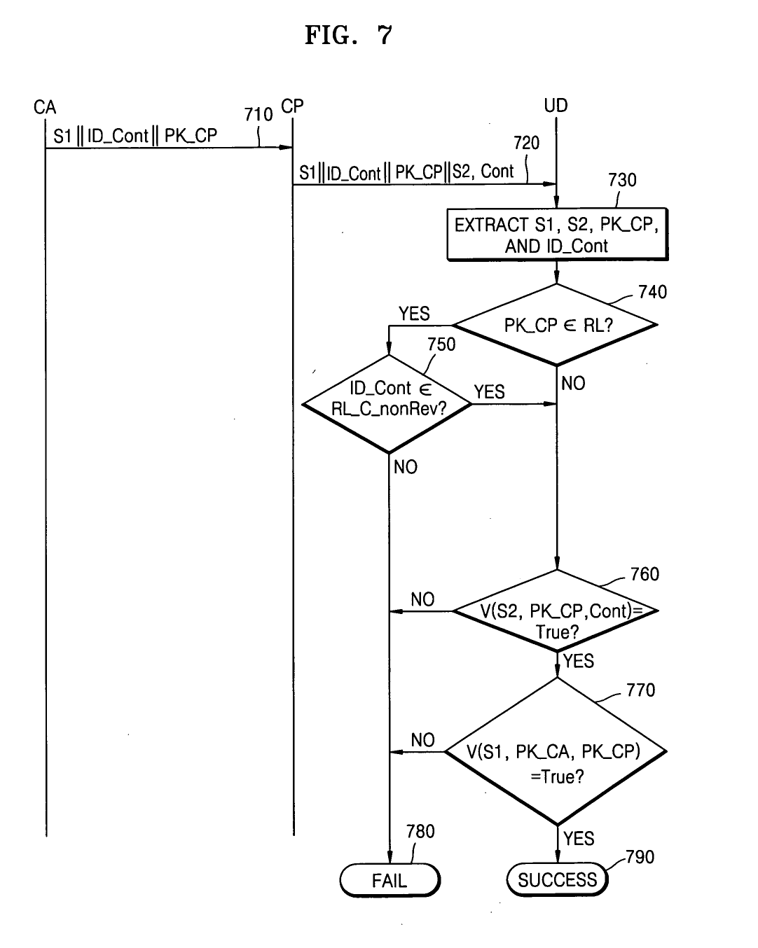

FIGS. 3 and 5 illustrate embodiments of the first method according to the present invention, and FIG. 7 illustrates an embodiment of the second method according to the present invention.

In detail, FIG. 3 is a flowchart of a method of revoking content authority Cont according to one embodiment of the present invention. FIG. 4 is a diagram illustrating a structure of a revocation list RL used in the method of FIG. 3.

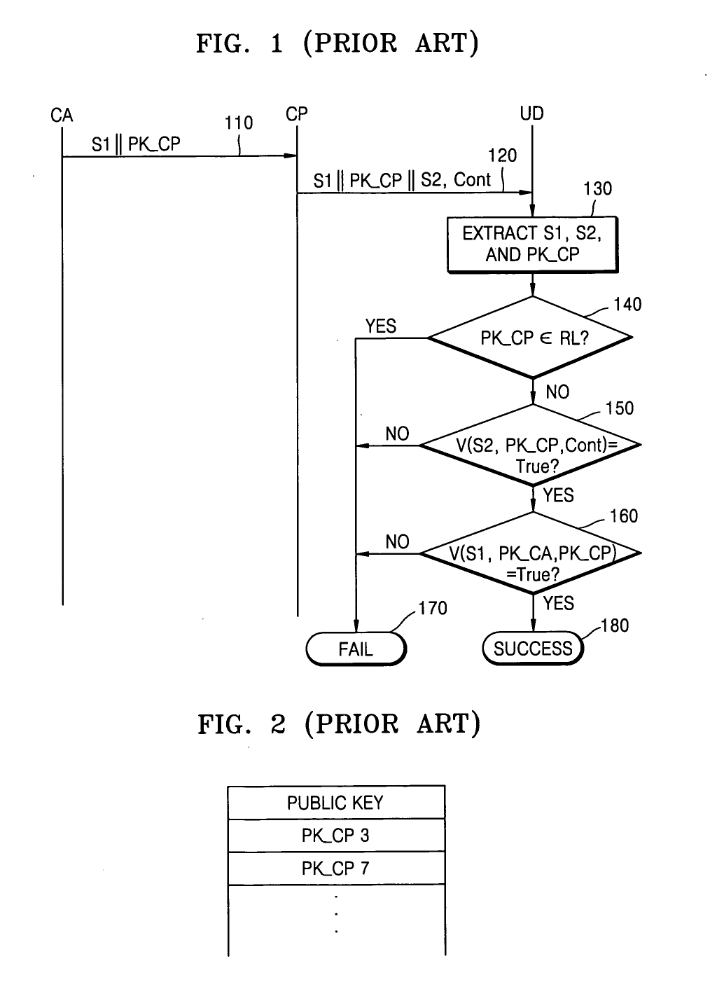

Referring to FIG. 3, a certificate authority CA makes a certificate C_CA_CP certifying a public key of a content provider CP and transmits it to the content provider CP (operation 310). The certificate C_CA_CP includes the time Ts, the public key PK_CP, and a signature value S1 generated by electronically signing a public key PK_CP of the content provider CP and a time Ts using a private key SK_CA of the certificate authority CA. The time Ts denotes a time when the signature value S1 is obtained. The method of FIG. 3 is different from that of FIG. 1 in that the signature value S1 is obtained by electronically signing both the public key PK_CP of the content provider CP and the time Ts. The certificate C_CA_CP is expressed as follows:
C_{—}CA_{—}CP=S1||Ts||PK_{—}CP=S(SK_{—}CA, Ts||PK_{—}CP)||Ts||PK_{—}CP (5)

Next, the content provider CP makes the content Cont and a certificate C_CP_UD certifying the content Cont and transmits them to a user device UD (operation 320). The certificate C_CP_UD includes the certificate C_CA_CP of the certificate authority CA, and a signature value S2 generated when the content Cont is electronically signed using a private key SK_CP of the content provider CP. The certificate C_CP_UD is expressed as follows:

$$C\_CP \_UD = C\_CA \_CP ‖ S 2 = S 1 ‖ Ts ‖ PK\_CP ‖ S 2 = S ( SK\_CA , Ts ‖ PK\_CP ‖ Ts ‖ PK\_CP ‖ S ( SK\_CP , Cont ) \qquad ( 6 )$$

Next, the user device UD extracts the signature values S1 and S2, the time Ts, and the public key PK_CP of the content provider CP from the certificate C_CP_UD (operation 330).

Next, the user device UD checks whether the revocation list RL includes the public key PK_CP extracted in operation 130 (operation 340). If the public key PK_CP is not included, the method proceeds to operation 360, and otherwise, the method proceeds to operation 350.

Referring to FIG. 4, the revocation list RL used in the method of FIG. 3 lists the public key PK_CP of a revoked content provider and a time Tr when the public key PK_CP is revoked. The revocation list RL is safely transmitted from the certificate authority CA or a third authority to the user device UD.

The user device UD determines whether the time Ts extracted in operation 330 is earlier than the time Tr listed in the revocation list RL (operation 350). If the time Ts is earlier than the time Tr, the method proceeds to operations 360 and 370, and otherwise, the method proceeds to operation 380.

In operations 360 and 370, whether the public key PK_CP is valid and whether the time Ts has been modified are determined.

The user device UD determines whether verification of the content Cont succeeds or fails by inputting the signature value S2 and the public key PK_CP of the content provider CP and the content Cont into a verification function V( ) (operation 360). That is, whether the content Cont is signed using the private key SK_CP is verified. In this case, the verification function V( ) is expressed as follows:
V(S2, PK_{—}CP, Cont)=V(S(SK_{—}CP, Cont), PK_{—}CP, Cont)=Success or Fail (7)

If the verification succeeds, the method proceeds to operation 370, and otherwise, the method proceeds to operation 380.

The user device UD determines whether the public key PK_CP is valid and whether the time Ts is modified by inputting the signature value S1, the public key PK_CA of the certificate authority CA, the time Ts extracted from operation 330, and the public key PK_CP of the content provider CP into the verification function V( ) (operation 370). In this case, the verification function V( ) is given by Equation (8). Unlike in the method of FIG. 1, the signature value S1 is obtained by electronically signing both the public key PK_CP and the time Ts.
V(S1, PK_{—}CA, Ts||PK_{—}CP)=V(S(SK_{—}CA, Ts||PK_{—}CP), PK_{—}CA, Ts||PK_{—}CP)=Success or Fail (8)

The user device UD does not authenticate the content provider CP as an authorized content provider, and rejects reproduction of the content Cont (operation 380). That is, the user device UD determines the content provider CP as a revoked content provider when it is determined in operation 340 that the public key PK_CP is included in the revocation list RL and it is determined in operation 350 that the time Ts is later than the time Tr; determines that the content provider CP disguises himself or herself as another content provider when it is determined in operation 360 that verification fails; and determines that the time Tr is altered when it is determined in operation 370 that verification fails. In these cases, the user device UD rejects production of the content Cont.

In operation 350, when the time Ts is earlier than the time Tr, the public key PK_CP is not revoked and the method proceeds to operation 360 even if the public key PK_CP is included in the revocation list RL. In other words, the user device UD can distinguish between a time Ts_A when a signature is generated when content Cont_A is transmitted from a content provider CP1, and a time Ts_B when a signature is generated when content Cont_B is transmitted from the content provider CP1. Accordingly, the user device UD can selectively determine whether each content authority is revoked.

In the method of FIG. 3, the time Ts is included in the signature value S1 of the certificate authority CA in operation 310, and verified when the signature value S1 is verified in operation 370. If the user device UD arbitrarily changes the time Ts transmitted in operation 310, verification in operation 370 will fail. Therefore, the user device UD should be prevented from changing the time Ts, and the security of content in the method of FIG. 3 should be protected.

Alternatively, verification of the public key PK_CP (operations 360 and 370) may be omitted. However, in this case, the user device UD can manipulate the time Ts.

Alternatively, operation 340 to determine whether the public key PK_CP is revoked may be performed after verifying the public key PK_CP (operations 360 and 370). That is, according to the present invention, the order of performing operations 340, 350, and 370 can be changed.

The method of FIG. 3 is a two-step process in which the certificate authority CA authenticates the content provider CP. However, according to the embodiments of the present invention, an upper certificate authority may further authenticate the certificate authority CA. In this case, the present invention further includes an operation in which the upper certificate authority issues a certificate certifying the certificate authority CA using an electronic signature, and an operation in which the user device UD verifies a signature value of the upper certificate authority.

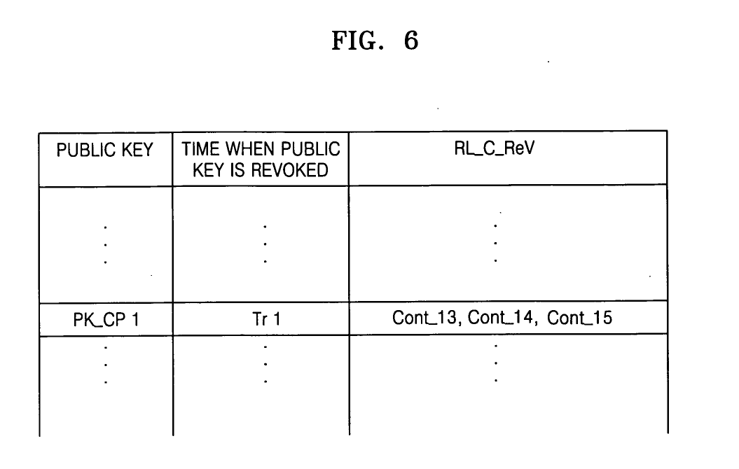

FIG. 5 is a flowchart of a method of revoking content authority Cont according to another embodiment of the present invention. FIG. 6 is a diagram illustrating a structure of a revocation list RL used in the method of FIG. 5.

Referring to FIG. 5, a certificate authority CA generates a certificate C_CA_CP certifying a public key PK_CP of a content provider CP and transmits it to the content provider CP (operation 510). The certificate C_CA_CP includes a signature value S1 which is obtained by electronically signing a content identifier ID-Cont, a time Ts when the signature S1 is generated, and the public key PK_CP using a private key SK_CA of the certificate authority CA; the content identifier ID_Cont, the time Ts, and the public key PK_CP. The method of FIG. 5 is different from that of FIG. 1 in that the signature value S1 is obtained by electronically signing the public key PK_CP of the content provider CP, the content identifier ID_Cont, and the time Ts. The certificate C_CA_CP is expressed as follows:

$$C\_CA \_CP = S 1 ‖ ID\_Cont ‖ Ts ‖ PK\_CP ‖ = S ( SK\_CA , ID\_Cont ‖ Ts ‖ PK\_CP ) ‖ ID\_Cont ‖ Ts ‖ PK\_CP \qquad ( 9 )$$

Next, the content provider CP makes content Cont and a certificate C_CP_UD certifying the content Cont and transmits them to a user device UD (operation 520). The certificate C_CP_UD includes the certificate C_CA_CP, and a signature value S2 obtained by electronically signing the content Cont using the private key SK_CP of the content provider CP. The certificate C_CP_UD is expressed as follows:

$$C\_CP \_UD = C\_CA \_CP ‖ S 2 = S 1 ‖ ID\_Cont ‖ Ts ‖ PK\_CP ‖ S 2 = S ( SK\_CA , ID\_Cont ‖ Ts ‖ PK\_CP ) ‖ ID\_Cont ‖ Ts ‖ PK\_CP ‖ S ( SK\_CP , Cont ) \qquad ( 10 )$$

Next, the user device UD extracts the signature value S1, the content identifier ID_Cont, the time Ts, the public key PK_CP of the content provider CP, and the signature value S2 from the certificate C_CP_UD (operation 530).

Next, the user device UD determines whether the revocation list RL includes the public key PK_CP extracted in operation 530 (operation 540). If the public key PK_CP is not included, the method proceeds to operation 560, otherwise, the method proceeds to operation 550.

Referring to FIG. 6, the revocation list RL used in the method of FIG. 5 includes the public key PK_CP of the revoked content provider CP, a time Tr when the public key PK_CP is revoked, and a content revocation list RL_C_Rev.

Next, the user device UD determines whether the time Ts extracted in operation 530 is earlier than the time Tr (operation 550). If the time Ts is earlier than the time Tr, the method proceeds to operation 555, otherwise, the method proceeds to operation 580.

Next, the user device UD determines whether the content revocation list RL_C_Rev of the revocation list RL includes the content identifier ID_Cont extracted in operation 530 (operation 555). When the content identifier ID_Cont is included, the method proceeds to operation 580, and otherwise, the method proceeds to operation 560.

In operations 560 and 570, whether the public key PK_CP is valid and whether the user device UD changed the content identifier ID_Cont and the time Ts are determined.

The user device UD determines whether verification of the content Cont succeeds or fails by inputting the signature value S2 and the public key PK_CP of the content provider CP, and the content Cont into a verification function V( ) (operation 560). That is, whether the content Cont is signed using the private key SK_CP of the content provider CP is verified. In this case, the verification function V( ) is expressed as follows:
V(S2, PK_{—}CP, Cont)=V(S(SK_{—}CP, Cont), PK_{—}CP, Cont)=Success or Fail (11)

If the verification succeeds, the method proceeds to operation 570, and otherwise, the method proceeds to operation 580.

Next, the user device UD determines whether the public key PK_CP of the content provider CP is valid and whether the content identifier ID_Cont or the time Ts has been altered by inputting the signature value S1, and the public key PK_CA of the certificate authority CA, the content identifier ID_Cont extracted in operation 530, the time Ts, and the public key PK_CP of the content provider CP into the verification function V( ) (operation 570). The verification function V( ) is given by Equation (12). Unlike the method in FIG. 1, the signature value S1 is obtained by electronically signing the public key PK_CP of the content provider CP, the content identifier ID_Cont, and the time Ts.
V(S1, PK_{—}CA, ID_Cont||Ts||PK_{—}CP)=V(S(SK_{—}CA, ID_Cont||Ts||PK_{—}CP), PK_{—}CA, ID_Cont||Ts||PK_{—}CP)=Success or Fail (12)

In operation 580, the user device UD does not authenticate the content provider CP as an authorized content provider and rejects reproduction of the content Cont. More specifically, the user device UD determines that the content provider CP is a revoked content provider when it is determined in operation 540 that the public key PK_CP is included in the revocation list RL and it is determined in operation 550 that the time Ts is later than the time Tr, determines that the content provider CP disguises himself or herself as another content provider when the verification in operations 560 and 570 fails, and determines that the content identifier ID_Cont or the time Ts has been altered when the verification in operation 570 fails. In these cases, the user device UD rejects reproduction of the content Cont.

In the method of FIG. 5, a content identifier to be revoked is included in a revocation list, thereby allowing precise selection of an object to be revoked.

Similarly in the method of FIG. 3, according to the method of FIG. 5, a user device is capable of selectively determining whether each content authority is to be revoked, based on a comparison between a time when a signature is generated and a time when a public key of a content provider is revoked.

Also, in the method of FIG. 5, the content identifier ID_Cont and the time Ts are included in the signature value S1 of the certificate authority CA in operation 510, and the content identifier ID_Cont and the time Ts are verified when the signature value S1 is verified in operation 570. Accordingly, the user device UD cannot manipulate the content identifier ID_Cont and the time Ts, thereby increasing the security for the method of FIG. 5.

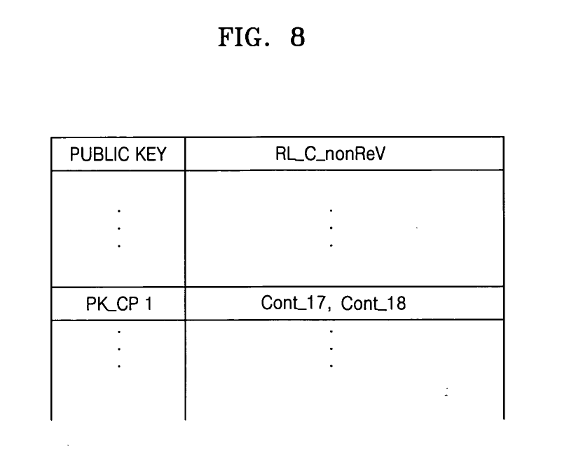

FIG. 7 is a flowchart of a method of revoking content authority Cont according to yet another embodiment of the present invention. FIG. 8 is a diagram illustrating a structure of a revocation list RL used in the method of FIG. 7.

Referring to FIG. 7, a certificate authority CA makes a certificate C_CA_CP certifying a public key PK_CP of a content provider CP and transmits it to the content provider CP (operation 710). The certificate C_CA_CP includes a signature value S1 obtained by electronically signing the public key PK_CP and a content identifier ID_Cont of the content provider CP using a private key SK_CA of the certificate authority CA; the content identifier ID_Cont; and the public key PK_CP of the content provider CP. The method of FIG. 7 is different from that of FIG. 1 in that the signature value S1 is obtained by electronically signing the public key PK_CP and the content identifier ID_Cont. The certificate C_CA_CP is expressed as follows:

$$C\_CA \_CP = S 1 ‖ ID\_Cont ‖ PK\_CP ‖ = S ( SK\_CA , ID\_Cont ‖ PK\_CP ) ‖ ID\_Cont ‖ PK\_CP \qquad ( 13 )$$

Next, the content provider CP makes a content Cont and a certificate C_CP_UD certifying the content Cont and transmits them to the user device UD (operation 720). The certificate C_CP_UD includes the certificate C_CA_CP, and a signature value S2 generated by electronically signing the content Cont using a private key SK_CP of the content provider CP. The certificate C_CP_UD is expressed as follows:

$$C\_CP \_UD = C\_CA \_CP ‖ S 2 = S 1 ‖ ID\_Cont ‖ PK\_CP ‖ S 2 = S ( SK\_CA , ID\_Cont ‖ PK\_CP ) ‖ ID\_Cont ‖ PK\_CP ‖ S ( SK\_CP , Cont ) \qquad ( 14 )$$

Next, the user device UD extracts the signature value S1, the content identifier ID_Cont, the public key PK_CP of the content provider CP, and the signature value S2 from the certificate C_CP_UD (operation 730).

Next, the user device UD determines whether the revocation list RL includes the public key PK_CP of the content provider CP extracted in operation 730 (operation 740). When the public key PK_CP is not included, the method proceeds to operation 760, and otherwise, the method proceeds to operation 750.

Referring to FIG. 8, the revocation list RL used in the method of FIG. 7 includes the public key PK_CP of a revoked content provider and an exception list RL_C_nonRev. The exception list RL_C_nonRev lists a content identifier of content that is not revoked although the public key PK_CP of the content provider CP who provides the content is included in the revocation list RL.

Next, the user device UD determines whether the content identifier ID_Cont extracted in operation 730 is included in the exception list RL_C_nonRev of the revocation list RL (operation 750). If the content identifier ID_Cont is included, the method proceeds to operations 760 and 770, and otherwise, the method proceeds to operation 780.

In operations 760 and 770, whether the public key PK_CP is valid and whether the user device UD modified the content identifier ID_Cont are determined.

The user device UD determines whether verification of the content Cont succeeds or fails by inputting the signature value S2 and the public key PK_CP of the content provider CP, and the content Cont into a verification function V( ) (operation 760). That is, whether the content Cont is signed using the private key SK_CP is verified. The verification function V( ) is given by:
V(S2, PK_{—}CP, Cont)=V(S(SK_{—}CP, Cont), PK_{—}CP, Cont)=Success or Fail (15)

When the verification succeeds, the method proceeds to operation 770, and otherwise, the method proceeds to operation 780.

The user device UD determines whether the public key PK_CP of the content provider CP is valid and whether the content identifier ID_Cont has been altered by inputting the signature value S1 and the public key PK_CA of the certificate authority CA, the content identifier ID_Cont extracted in operation 730, and the public key PK_CP into the verification function V( ) (operation 770). The verification function V( ) is given by Equation (16). Unlike in the method of FIG. 1, the signature value S1 is obtained by electronically signing both the public key PK_CP of the content provider CP and the content identifier ID_Cont.

$$V ( S 1 , PK\_CA , ID\_Cont ‖ PK\_CP ) = V ( S ( SK\_CA , ID\_Cont ‖ PK\_CP ) , PK\_CA , ID\_Cont ‖ PK\_CP ) = Succes s or Fail \qquad ( 16 )$$

In operation 780 the user device UD does not authenticate the content provider CP as an authorized content provider and rejects reproduction of the content Cont. More specifically, the user device UD determines the content provider CP to be a revoked content provider when it is determined in operation 740 that the public key PK_CP is included in the revocation list RL and it is determined in operation 750 that the content identifier ID_Cont is not included in the exception list RL_C_nonRev, determines the content provider CP to disguise himself or herself as another content provider when the verification fails in operations 760 and 770, and determines that the content identifier ID_Cont has been altered when the verification fails in operation 770. In these cases, the user device UD rejects reproduction of the content Cont.

According to the method of FIG. 7, a revocation list additionally includes a content identifier of content that is not revoked although a public key of a content provider who provides the content is included in the revocation list. Accordingly, the user device can identify an object to be revoked, and thus, it is possible to prevent a properly authorized content from being revoked.

Also, in the method of FIG. 7, the content identifier ID_Cont is included in the signature value S1 of the certificate authority CA in operation 710, and verified when the signature value S1 is verified in operation 770. Therefore, the user device UD cannot alter the content identifier ID_Cont, thereby increasing the security for the method of FIG. 7.

A method of revoking a public key of a content provider according to the present invention can be realized as a computer program. Codes and code segments of the computer program can be easily inferred by computer programmers in the art. The computer program may be stored in a computer readable medium. When the computer program is read and executed by a computer, the method is realized. The computer readable medium may be any medium, such as a magnetic recording medium, an optical recording medium, or a carrier wave.

As described above, in a method of revoking a public key of a content provider according to the present invention, it is possible to allow a user device to identify content that must not be revoked by transmitting to the user device a revocation list which includes a time when content authority is revoked, and an exception list. Accordingly, it is possible to prevent rightly obtained content from being revoked.

Further, according to the present invention, it is possible to prevent a user device from counterfeiting or altering a content identifier or a time when a signature of a certificate authority is generated by generating a signature value of the certificate authority to include the content identifier or the time when the signature is generated.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of revoking a public key of a content provider in a system in which a certificate authority certifies the public key of the content provider and the content provider transmits predetermined content to a user device using the certified public key, the method comprising determining whether the predetermined content is revoked in the user device by comparing a time when a signature of the public key is generated with a time when the public key is revoked.

2. The method of claim 1, further comprising:
(a) the certificate authority electronically signing a time when the predetermined content is electronically signed and the public key of the content provider, and transmitting the result of signing to the content provider; and
(b) the content provider electronically signing the predetermined content and transmitting the predetermined content to the user device.

3. The method of claim 2, further comprising (c) the user device verifying the public key of the content provider and the time when the signature is generated.

4. The method of claim 3, wherein (a) comprises:
(a1) generating a signature value of the certificate authority by electronically signing the public key of the content provider and the time when the signature is generated, using a private key of the certificate authority;
(a2) transmitting the signature value of the certificate authority, the time when the signature is generated, and the public key of the content provider to the content provider.

5. The method of claim 4, wherein (b) comprises:
(b1) generating a signature value of the content provider by electronically signing the predetermined content using a private key of the content provider; and
(b2) transmitting the signature value of the certificate authority, the time when the signature is generated, the public key of the content provider, and the signature value of the content provider to the user device.

6. The method of claim 5, wherein (c) comprises:
(c1) determining whether the predetermined content is signed using the private key of the content provider by verifying the signature value of the content provider; and
(c2) determining whether the public key of the content provider is valid and whether the time when the signature is generated is manipulated by verifying the signature value of the certificate authority.

7. The method of claim 6, wherein (c1) comprises (c11) determining whether the predetermined content is signed using the private key of the content provider by verifying the signature value of the content provider by inputting the signature value and the public key of the content provider and the predetermined content into a verification function.

8. The method of claim 6, wherein (c2) comprises (c12) determining whether the public key of the content provider is valid and whether the time when the signature is generated is manipulated by inputting the signature value and the public key of the certificate authority, the time when the signature is generated, and the public key of the content provider into the verification function.

9. A method of revoking a public key of a content provider in a system in which a certificate authority certifies the public key of the content provider and the content provider transmits predetermined content to a user device using the certified public key, the method comprising the user device determining whether the predetermined content is revoked based on whether a content identifier of the predetermined content is included in an exception list which lists content identifiers of contents that must not be revoked.

10. The method of claim 9, further comprising:
(a) the certificate authority electronically signing a content identifier of the predetermined content and the public key of the content provider and transmitting the signed content identifier and the public key to the content provider; and
(b) the content provider electronically signing the predetermined content and transmitting the predetermined content to the user device.

11. The method of claim 10, further comprising (c) the user device verifying the public key of the content provider and the content identifier.

12. The method of claim 11, wherein (a) comprises:
(a1) generating a signature value of the certificate authority by electronically signing the public key of the content provider and the content identifier using a private key of the certificate authority;
(a2) transmitting the signature value of the certificate authority, the content identifier, and the public key of the content provider to the content provider.

13. The method of claim 12, wherein (b) comprises:
(b1) generating a signature value of the content provider by electronically signing a private key of the content provider; and
(b2) transmitting the signature value of the certificate authority, the content identifier, the public key of the content provider, and the signature value of the content provider to the user device.

14. The method of claim 13, wherein (c) comprises:
(c1) determining whether the predetermined content is signed using the private key of the content provider by verifying the signature value of the content provider; and
(c2) determining whether the public key of the content provider is valid and whether the content identifier is manipulated by verifying the signature value of the certificate authority.

15. The method of claim 14, wherein (c1) comprises (c11) determining whether the predetermined content is signed using the private key of the content provider by verifying the signature value of the content provider by inputting the signature value and the public key of the content provider, and the predetermined content into a verification function.

16. The method of claim 14, wherein (c2) comprises (c12) determining whether the public key of the content provider is valid and whether the content identifier is manipulated by inputting the signature value and the public key of the certificate authority, the content identifier, and the public key of the content provider into the verification function.

17. A computer readable recording medium having embodied thereon a computer program for executing the method of claim 1.
